(19) United States
(12) Patent Application Publication
(10) Pub. No.: US 2017/0055004 A1
(43) Pub. Date: Feb. 23, 2017

(54) MULTIPOINT CAPTURE OF VIDEO AND DATA PROCESSING AND DISTRIBUTION

(71) Applicants: Andrew Robinson, Rolling Hills, CA (US); Mark Howard Krietzman, Rolling Hills, CA (US)

(72) Inventors: Mark Krietzman, Palos Verdes estates, CA (US); Andrew Robinson, Virginia Beach, VA (US)

(21) Appl. No.: 14/827,379

(22) Filed: Aug. 17, 2015

(51) Int. Cl. H04N 21/218; H04N 21/242; H04N 21/431; H04N 21/81; H04N 21/234; H04N 21/258; H04N 21/2668; H04N 21/262; H04N 5/45

(52) U.S. Cl. CPC H04N 21/21805; H04N 21/262; H04N 21/242; H04N 21/4316; H04N 5/45; H04N 21/23424; H04N 21/25883; H04N 21/2668; H04N 21/812; H04N 21/8133

(57) ABSTRACT

A system and method to generate, collect, archive and/or agglomerate specific sensory, audio, gps, and video content which may be distributed time synched with and to augment the broadcast of an event, the event within the confines of an event site. Collecting the data with digital capture devices (DCA) mounted on at least two of drones, humans and fixed; collecting positional data on each DCA relative to an object at the event site; transmitting the captured data via signal communications to a sever; processing the captured data at the servers; and at least one of editing, archiving, distributing and transmitting a data feed stream generated from the DCA data.

### CROSS-REFERENCE TO RELATED APPLICATION

This application claims the priority to U.S. (“U.S.”) Provisional Patent Applications Ser. Nos. 62038339 filed Aug. 17, 2014 and 62046148 filed Sep. 4, 2014 the disclosure of which is incorporated by reference herein in its entirety.

### BACKGROUND OF THE DISCLOSURE

1. Field of the Disclosure

The present disclosure relates generally to capture of data associated with an object at a defined event, by multiple capture devices, producing streams of data which may be linked with advertising and other data.

2. Related Art

Video cameras may be mounted on helmets or vehicles. Stationary cameras are known. Watching an event or gaming event on broadcast television or IPTV may be paused for commercials or breaks in the action.

### SUMMARY

Disclosed herein are devices used within or forming a method and system for capturing multiple first person views of at least one of a portion of an event and an objects at the event. In some instances the object being a physical thing such as an American football, cricket ball, soccer ball, baseball, tennis ball, basketball, softball, boxing glove(s), puck and the like.

Groups consisting of members interact for a common goal, game or sport against another person or another group. The interaction includes attempting to capture, use, score with or stop scoring with an object.

B In some instances a Digital Capture Assets (DCA) has one or more of processors, volatile memory, non-volatile memory, microprocessors, D-RAM, RAM, software and hardware and is connected to, or includes, power supply and an antenna for transmitting and/or receiving signals. DCA may capture more than just audio and video.

A system and method to generate, collect, archive and/or agglomerate specific sensory, audio, gps, and video content which may be distributed time synched with and to augment the broadcast of an event, the event within the confines of an event site. Collecting the data with digital capture devices (DCA) mounted on at least two of drones, humans and fixed; collecting positional data on each DCA relative to an object at the event site; transmitting the captured data via signal communications to a sever; processing the captured data at the servers; and at least one of editing, archiving, distributing and transmitting a data feed stream generated from the DCA data.

Aspects of exemplary implementations disclosed herein include a system to agglomerate specific video content which may be distributed time synched with and to augment the broadcast of a gaming event, the system comprising: within the confines of an event site during a gaming event, collecting first person point of view video via digital capture devices (DCA) mounted on two or more human actors; collecting positional data on each of said actors relative to an object at the event site; transmitting the captured data via signal communications to a sever; processing the captured data at the servers; editing the data feed whereby the servers distribute a feed stream of data showing video of a selected object time synced with a game clock suitable for use as a picture in picture during the broadcast or streaming of the gaming event. The object in some instances may be a specific actor, or a game ball. The system of claim 1 wherein the object is a ball.

Aspects of exemplary implementations disclosed herein include a system to agglomerate specific data which may be distributed time synched with and to augment the broadcast of a gaming event, the system comprising: within the confines of an event site during a gaming event, collecting first person point of view video via digital capture devices (DCA) mounted on actors; collecting positional data on each of said actors relative to at least one other specified actor; transmitting the captured data via signal communications to a sever; processing the captured data at the servers to create a timeline, synced with the game clock, of actor views of an object; distributing a feed stream of actor view data showing video of the selected object time synced with a game clock.

Aspects of exemplary implementations disclosed herein include a system to agglomerate specific data which may be distributed time synched with and to augment the broadcast of a gaming event, the system comprising: within the confines of an event site during a gaming event, collecting first person point of view video via digital capture devices (DCA) mounted on actors; collecting positional data on each of said actors relative to at least one other specified actor; transmitting the captured data via signal communications to a sever; processing the captured data at the servers to create a timeline, synced with the game clock, of actor views of an object; distributing a feed stream of actor view data showing video of the selected object time synced with a game clock; and, adding enhanced data to an actors video corresponding to information about the actor connected to the DCA. In some instances the enhanced data is jpeg, mpeg, music, audio, advertisement, YOU-TUBE™ like video, webpage, messages, brand endorsement. In some instances the enhanced data is an overlay or insert of information such as face, age, weight, statistics, TWITTIER™ feed, FACEBOOK™, INSTAGRAM™, database link, or other link for social media or hyperlink that links to provide the viewer content which could be audio, olfactory, or direct a viewer to (or open) another screen that is the content.

Aspects of exemplary implementations disclosed herein include methods to agglomerate specific event content which may be distributed after an event with a time sync to augment the distribution of the agglomerated content, including a specified area collecting video, sensor and audio data via DCA associated with two or more of actors, non-actors, drones and fixed; transmitting the captured data via signal communications to a sever; processing the captured data at the servers to create a timeline, synced with a clock, of DCA data feed showing views of one or more selected objects; distributing a feed stream the processed DCA data feed to one or more members of a population; distributing with the feed stream one or more targeted advertisements, targeting based on at least some of the demographic data associated with viewers from the population that follows a player or actor associated with the data feed. In some instance the advertising feed is distributed to a second display which is part of a local area network.

### BRIEF DESCRIPTION OF THE FIGURES

The invention may be better understood by referring to the following figures. The components in the figures are not necessarily to scale, emphasis instead being placed upon illustrating the principles of the invention.

FIG. 1A is a diagram of aspects of a multipoint data collection (MDC) system and method and associated distribution applied to at least one of collecting, processing and disseminating a processed set of data acquired via data capture devices from actors on teams including but not limited to ID, positional, video, audio, biometric, direction of travel and rate of travel via signal communications;

FIG. 1B is a diagram of aspects of a system and method disclosed herein applied to at least one of collecting, processing and disseminating a processed set of data acquired via data capture devices from actors on teams, person at an event site, moving robot or remote devices, fixed devices including but not limited to ID, positional, video, audio, biometric, direction of travel and rate of travel via signal communications;

FIG. 2A is a an overview of aspects of a system and method disclosed herein applied to collecting, with data capture devices, and sending to servers via signal communications a plurality of data feeds which include some feeds from actors point of view and one or more of archiving, processing, modifying, editing, layering and disseminating at least some portion of the acquired or processed captured data to populations, sub-populations and broadcasters for use;

FIG. 2B is a an overview of aspects of a system and method disclosed herein applied to the downstream collection (via signal communications), and uses, of a plurality of data feeds which include some feeds from actors point of view. Uses include one or more of archiving, processing, modifying, editing, layering and disseminating at least some portion of the acquired or processed captured data to populations, sub-populations and broadcasters for use;

FIGS. 3 and 4 illustrates individual actors within a group or team a non-exclusive listing of data which may be acquired, and transmitted to servers for processing, by actor mounted capture devices;

FIG. 5 is a process flow of some aspects of some exemplars to process collected data for distribution;

FIG. 6A is a process module flow and six, non-limiting, sub-modules for processing data collected from a multitude of parallel acting digital capture devices and transmission of one or more data feeds polished via processing to one or more population, subpopulation or for broadcast uses.

FIG. 6B is a more detailed process flow of sub module “F” of FIG. 6A;

FIG. 6C is a more detailed process flow of sub module “C” of FIG. 6A;

FIGS. 7A-7F show a viewer facing display and some aspects of the data feeds which can be provided thereon, including links and enhanced information;

FIGS. 8-11 show viewer facing displays and some aspects of the data feeds which can be provided thereon and use of screen display real estate;

FIGS. 12A and 12B provide a menu view of a population member selecting a type, category or identifying a data feed or data feed source to be processed or polished for viewing or streaming to the populations member;

FIGS. 13-14 show a touch screen for selecting one of teams (groups), actors and other assets to be processed or polished for viewing or streaming to the populations member;

FIG. 15 shows an interaction with a on screen menu of a TV, cable company, satellite TV company, iptv, gaming system, set top box or streaming device such as a ROKU™ or FIRE™ or APPLETV™ with game schedules that link to a submenu for selecting data feeds to be associated with or accompany the game (or other event) viewing experience.

FIG. 16A shows time line capture of a surfing actor according to aspects of the disclosure.

FIG. 16B shows a display screen and linked display with data feed from the capture illustrated in FIG. 16A and with linked advertising.

In the figures, like reference numerals designate corresponding parts throughout the different views. All callouts and annotations are hereby incorporated by this reference as if fully set forth herein.

### DETAILED DESCRIPTION

### Overview:

At a simplified level aspects of the system and method disclosed herein include utilizing hardware referred to as Digital Capture Assets (DCA) to acquire, receive, measure or otherwise capture and then transmit via signal communication data associated with an event and objects. In some instances the DCA also contains a processor which will process at least some of the data acquired prior to signal communication.

In a game example, groups of actors (players) are in a competition. In a simple example all players have DCA mounted to them. The example should not be read to require each and every player to have a DCA in all instances but for simplicity is being described that way to reduce variables in a simple overview. The object(s) span the gambit from a game ball to another player who is selected to be “of interest” at a particular time for a reason. The reasons and time are all based on instruction from the serves which process the DCA data feeds. Data feeds of information from the players' DCAs are transmitted by signal communication to servers which process the data. The data feed may be encrypted.

The players' data feed information may be run through a quality control (QC) algorithm to remove out poor quality or unreliable data early on to reduce the quantity of data which needs to be further processed. Positional, identification (wifi, near field, RFID, other tag), facial, and other optical recognition processes may be used to place the data feeds in a hierarchy of higher value to lower value feeds. Value, however, may be dynamic. A population which is wholly interested in seeing the closest feeds to a game ball from team ones' point of view will be different than a population that wants to view a play from the point of view of players “a”. “b” and “e” when available. The processing done by rule, decision engines which may utilize heuristic decisioning may also vary based on the output feed for a particular entity, person or population.

In some instances the DCA acquires data such as video, and at least one of positional data from the actors point of view, relative an actor, or relative to other actors or object(s) in an enclosed environment, audio, health measurements, speed, acceleration, force potential (derived from an actor's weight and acceleration (F=ma)) which is collected. In some exemplars the collection may take place in a defined space over a defined time interval.

In a simple example the DCA are deployed on actors and they collect specific data, video, audio, speed, motion, position, heart rate, blood pressure, wind speed, movement, temperature from a actors point of view position. The DCA may be a computing

device with plug in sensors, DCAs may each be a computing device, DCAs may be a streaming data device with signal communications capabilities. DCA's will often have processors, memory and will be in or be connected to a device in signal communications with at least a server for processing data feeds. In the example of a sporting event the members of a team are first actors and the members of another team are second actors. One or more actors on each team has one or more DCA mounted thereon. Actor movement and independent choice define the movement of the DCA during the event. It is preferred that an event site space is equipped to receive steams of data from a plurality of DCAs digital a data rate which allows for near real time or real time processing at servers and streaming of processed data in the form of feeds to populations or sub populations.

The computing devices and smart devices disclosed herein operate with memory and processors whereby code is executed during processes to transform data, the computing devices run on a processor (such as, for example, controller or other processor that is not shown) which may include a central processing unit (“CPU”), digital signal processor (“DSP”), application specific integrated circuit (“ASIC”), field programmable gate array (“FPGA”), microprocessor, etc. Alternatively, portions DCA devices may also be or include hardware devices such as logic circuitry, a CPU, a DSP, ASIC, FPGA, etc. and may include hardware and software capable of receiving and sending information.

DCAs in some instances are mounted on actors (human). In some instances DCAs are mounted to remote, robot, autonomous or semi-autonomous drones. DCAs in some instances are mounted to actors (human) and drones. DCAs in some instances include held or worn glasses or phones which actors (human) capture data. DCAs in some instances include drones mounted capture devices and fixed capture devices. DCAs in some instances include mounted or held on actors (human) capture devices, drones mounted capture devices and fixed capture devices.

Processors having memory in servers executing instructions collected the digital media feeds and process them to provide a specific feed, set of feeds or a compilation of feeds. The processing may be for a large population and may provide the same feed, or for sub populations and may provide each a specified feed. Decision and Rule engines, in some cases utilizing heuristic logic, collect, render and process digital media feeds for distribution to a population or subpopulation. Feeds may also be stored in a database. In some instances advertising media is layered with, insert, or placed in the distributed digital media data. In some instances enhanced information is used to augment the players point of view feed. For example player “a” may be viewing player “e” servers may add an overlay or insert of information concerning player “e” such as his face, age, weight, statistics, or other information about or related to player “e” such as TWITTER™ feed, INSTAGRAM™, database, or other link for social media or hyperlink

that link in some instances may be live and can be selected to provide the viewer content which could be audio, olfactory, or direct a viewer to (or open) another screen that is content from the link, such as jpeg, mpeg, music, audio, or an advertisement, you-tube like video, webpage or the like. The enhanced information content may be a rating of the player or the players point of view feeds anecdotal information, or messages from actor “e” such as thought for day, motto, brand endorsement. It may be that advertising media is layered with, insert, or placed in the distributed digital media data. In some instances the messages from player “e” may be varied or change, in some instances the messages may be randomized, in some instances the messages may be sequenced or set to trigger by a predetermined event.

In other cases when viewing from player “a” point of view a hyperlink [1260] may add an overlay or insert of information concerning player “a” such as his face, age, weight, statistics, or other information about or related to player “a” such as TWTTIER™ feed, INSTAGRAM™, database link, or other link for social media or hyperlink that links to provide the viewer content which could be audio, olfactory, or direct a viewer to (or open) another screen that is content from the link, such as jpeg, mpeg, music, audio, or an advertisement, you-tube like video, webpage or the like. The enhanced information content may be a rating of the player or the players point of view feeds anecdotal information, or messages from actor “a” such as thought for day, motto, brand endorsement. It may be that advertising media is layered with, insert, or placed in the distributed digital media data. In some instances the messages from player “a” may be varied or change, in some instances the messages may be randomized, in some instances the messages may be sequenced or set to trigger by a predetermined event. Advertising media, in some instances, is targeted to a viewer following a specific player, a viewer who is following feed from player or actor “a” may be provided an advertisement which based on the demographic data associated with viewers that follow that player or actor are more likely to respond to in a positive way.

### More Exemplars:

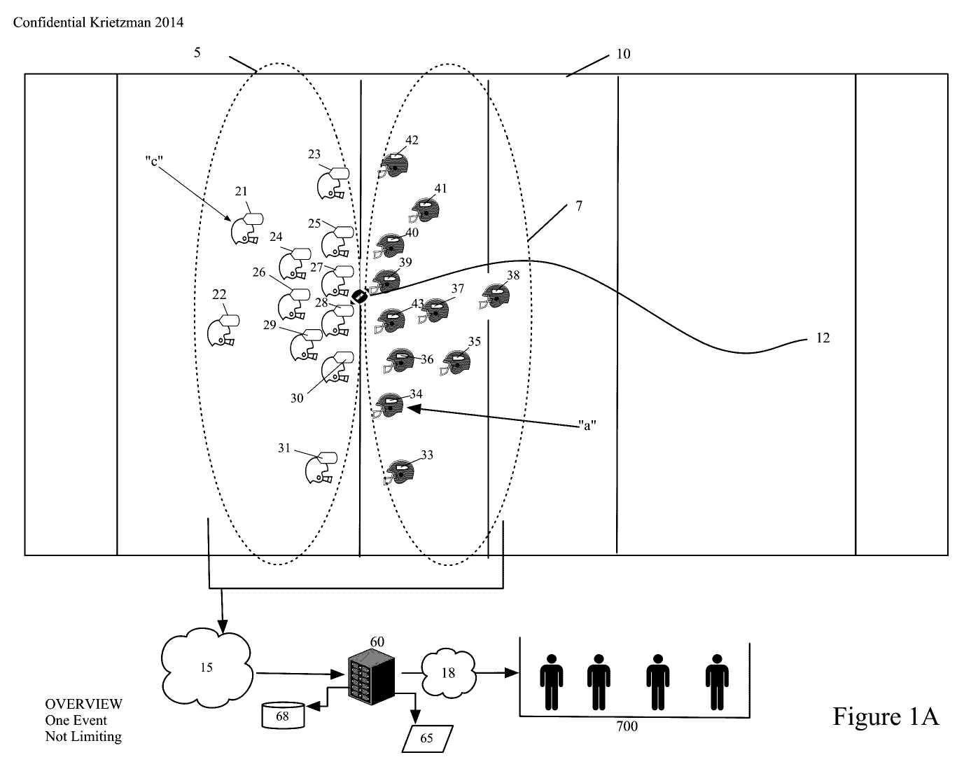

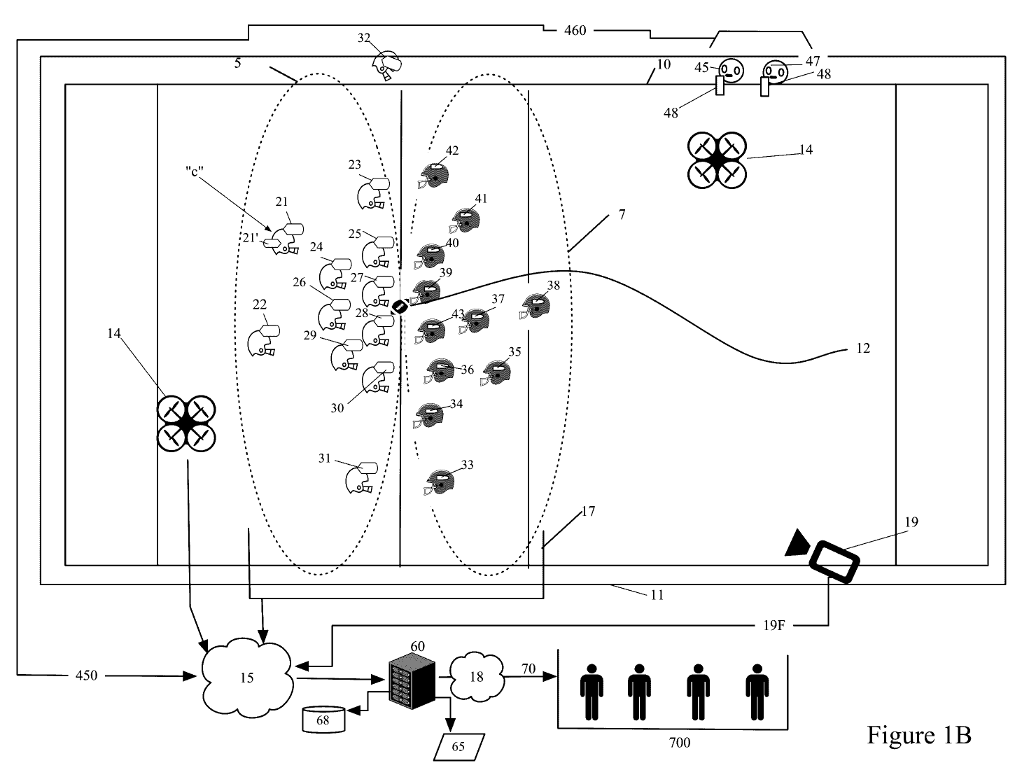

FIGS. 1A and 1B are overviews of some aspects of the system and methods disclosed herein. In this football example there is an epic battle between two 5 and 7 in a defined event location 10 which ahs a periphery (area around the event but adjacent) and at least one object 12. The teams have players. On the first team, team 5 the players are designated 21-31 and they may also be referred to by IDs such as “c” who is player 21. Player or actor “a” is called out as a member of the second team 7. The second team has players 33-43 and player “a” is designated as 34.

Each actor (player) in this exemplar has at least one digital capture asset (DCA). In this exemplary implementation a DCA provides at least power supply, processors, video and audio capture and at least on of the following: antenna, digital memory, clock, location finder (gps, near field, wifi etc.), wireless signal transmission, wireless signal reception, sonar, laser emitter and receptor, body sensors, health sensors, other sensors such as receptors and emitters for measuring distance between objects, identification of other players or objects, recognition, or spectral emitters.

Data captured by or associated with actors can be transmitted as digital signals via one or more networks 15 which may be secure, closed, open, public, proprietary, or encrypted. The DCA are in signal communication with such networks wherein the player DCAs provide data feeds 17.

It is appreciated by those skilled in the art that some of the circuits, components, modules, and/or devices of the system disclosed in the present application are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying analog and/or digital formats without passing through a direct electromagnetic connection. These information paths may also include analog-to-digital conversions (“ADC”), digital-to-analog (“DAC”) conversions, data transformations such as, for example, fast Fourier transforms (“FFTs”), time-to-frequency conversations, frequency-to-time conversions, database mapping, signal processing steps, coding, modulations, demodulations, etc.

Data may be associated with an identified actor, identification may be via RFID, facial recognition, other optical tag or spectral tag from a spectral emitter. Optical recognition via machine vision or processing of a video data set can be used for optical identification and spectral or RFID analysis. The analysis may be at the DCA, post signal communication or occur partially at the DCA and partially at servers 60 in signal communication with the DCA. The server(s) in turn process 68 the data and may store at least some portion in an archive or database 68.

In practice, the digital data feed captured by DCAs associated with actors and/or the data associated with the actors (such as position, speed, heart rate, temperature, other biometrics) are then provided to one or more servers 60 for processing 65. Servers may be connected to databases or archives 68. The processed data can then provided to a population 700. There are multiple ways, which the processing may be done in sequence, in parallel, over a distributed system, thereafter a edited, enhanced, polished or otherwise modified data stream (which may have overlaid data making it a complex stream of multiple types of data sources) can be distributed to an entity, person, subpopulation or population 700 through a network 15/18 such as internet, cable, satellite, wired, streaming, wireless, and broadcast. The processed data is preferably rendered for the display screen it is to be shown on. The to be distributed data may be sent encrypted and the recipient may be provided an encryption key.

Actors on the first team 5 each have a DCA 21-31 and each DCA captures data the near the actor or associated with actors and is able to at least transmit the data. Actors on the second team 7 each have DCA 33-43 associated with them and is able to at least transmit the data. In some instance a DCA also receive signal communications from a server 60 wherein adjustment of parameters of the DCA may be instructed. In some instance multiple DCA such as 21 and 21′ may be used by one actor.

FIG. 1B shows two teams of unequal numbers. The first team 5 has twelve actors and one sidelined actor 32 is not on the event site 10 but rather is in a defined periphery 11. Each actor has at least one digital capture asset (DCA) in this case the DCA provides at least power supply, digital processors, video and audio capture. In some instances additional features of the at least one DCA are antenna, digital memory, clock, location finder (gps, near field, wifi etc.), wireless signal transmission, wireless signal reception, sonar, laser emitter and receptor, other receptor and emitter for measuring distance between objects.

Actors on first team 5 each have DCAs 21-32 and each have at least one DCA which captures data the near the actor or associated with actors and is able to at least transmit the data. Actors on the second team 7 each have one DCA, and each DCA captures data the near the actor or associated with actors and is able to at least transmit the data. In some instances a DCA will also receive signal communications from a server which may adjust parameters of the DCA.

Drone(s) 14 with DCA mounted thereon can provide additional data feeds 450 to the servers 60. Fixed DCA 19 can provide additional data feed 19F to the servers 60 and spectator(s) 45 and or other non-actor 47 (coach, designated person, celebrity, spouse, child, referee, owner, analyst, comedian, blogger, friend, guest and the like) may provide data feeds 460 to the servers 60 via their DCAs 48. Any devices, including player, drone, fixed, spectator and non-actor other devices may be registered with servers 60 through a website or App. Registered devices may be provided limited authorization to stream or upload to contribute data streams to the server 60. In some instances those with, providing, who own, or using DCAs may be provided incentives to one of register and contribute data.

### Further Exemplars:

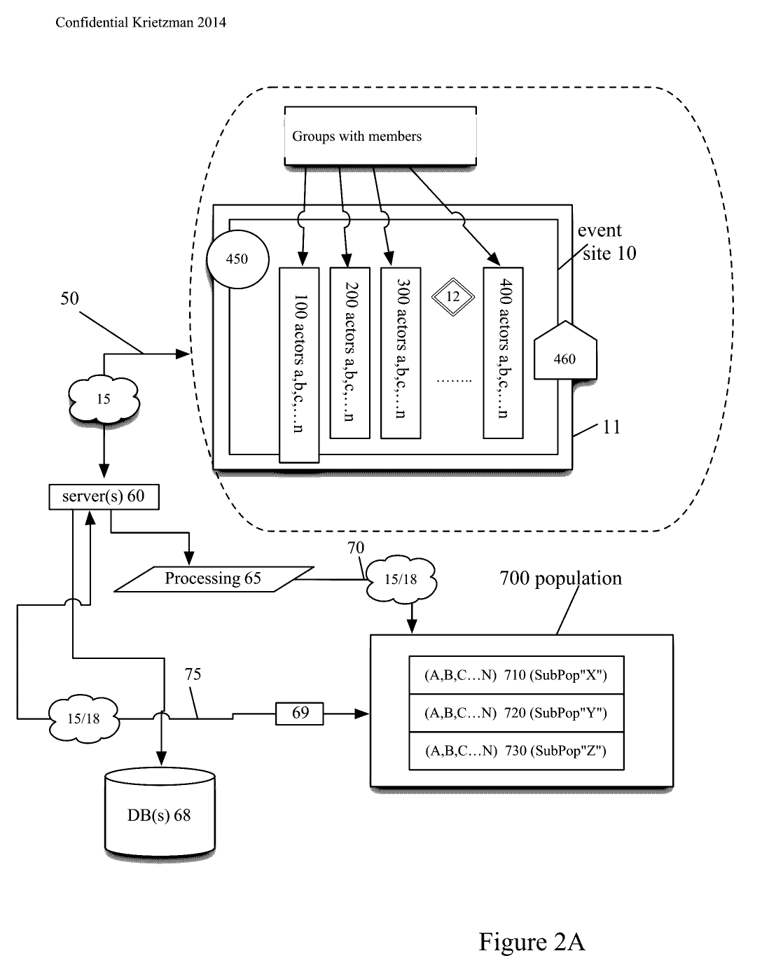

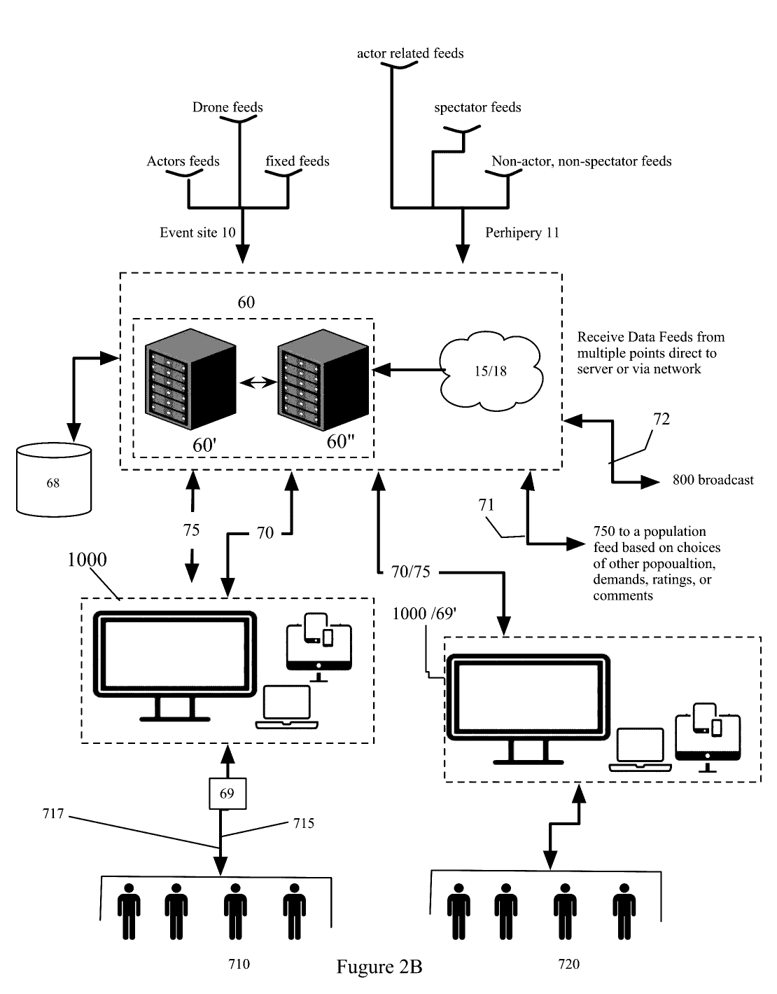

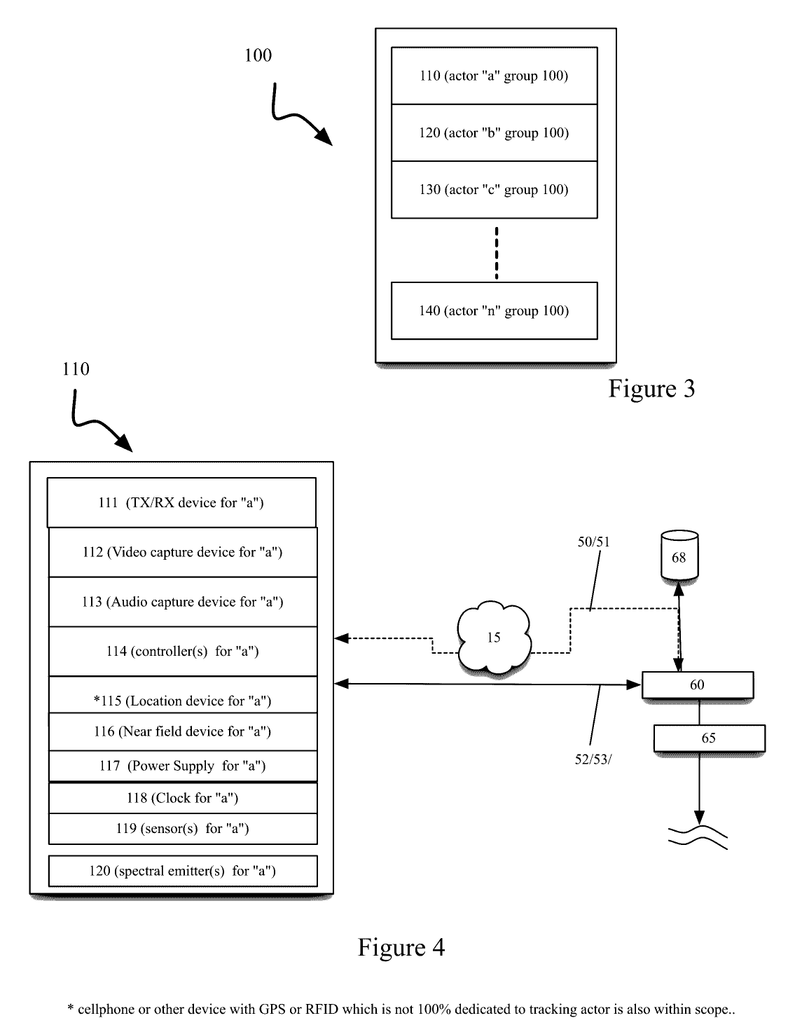

In FIGS. 2A and 3B there is illustrated a general overview of the data which is at least one of collected/captured, processed and distribution of the systems and methods disclosed herein. At an event site 10 with a defined periphery 11 groups (100-400) with members (a-n) are located. An object 12 or objects is identified. A first group 100 is comprised of actors “a”-“n” all being live and not robotic, drone or electronic. Each with the capacity for independent thought an action. A second group 200 is comprised of actors “a”-“n” all being live and not robotic, drone or electronic. A third group 300 is comprised of actors “a”-“n” at least some of which are live and not robotic, drone or fixed. A fourth group 400 is comprised of actors “a”-“n” being robotic and drone.

Fixed DCA feeds 19F, spectator feeds 360 and drone feed 450 are also shown provided via signal communication to the servers 60 via a network 15.

Data captured by actors, or associated with actors is transmitted 50 as digital signals via signal communications over one or more networks 15 to servers 60 and may also be received in parallel. The servers are computing devices 60 and using software processes 65 the captured data using one or more of rule engines, decision engines, and heuristic tools to identify the high value data. The high value data is data which is related more closely to a selected object 12. The object may change or vary. The high value data is identified based on criteria including but not limited to quality, duration, location to the object, specification of a end user or customer who will eventually receive a transmission 70.

Although the exemplar is discussed in terms of providing a single transmission 70, it is not limited to such a single transmission, It is within the scope of this disclosure, and those of ordinary skill in the art will recognize that, the transmission may include multiple streams of data from actors which have been processed but are displayed as separate views or overlaid views or ticket line displays on a display device to an end user of a population.

A population 700 which may be comprised of subpopulations received a feed 70. First subpopulation “X” 710, second subpopulation “Y” 720, and third subpopulation “Z” 730 are examples only. Those of ordinary skill in the art will recognize that more or fewer subpopulations may be distributed to. In fact individual; members “A”-“N” may have individualized sub-sub population feeds distributed to them.

The population or subpopulation and the server 60/60′ interact 75. That interaction is via computing devices 69 (which include smart phones, smart TVs, gaming stations, set top boxes, streaming video devices, remote controls, laptops, tablets and the like). Those interactions may include on or more of include requests 715 for specific content, enhanced information, linked information, rating, comments, and the like. The interactions in some instances may include the uploading of a comment 717 or rating. In some instances the computing device 69′ is also the display device 1000.

Servers 60/60′ may receive DCA feed directly from the DCA via wifi, whitespace broadcast, near field and the like, or via a network 15/18.

FIG. 3 illustrates how a first group 100 is comprised of individual actors 100-140. FIG. 4 illustrates data capture via the DCA of an actor in a group. For example actor “a” of the first group 100 is designated 110. The affixed, mounted or otherwise connected DCAs include at least one of transmitter, receiver and antennae 111, video capture device 112, audio capture device 113, controller 114 which can send and receive instructions to other devices. Other DCAs may include location device 115, near field device 116, power supplies 117, clock or timer which may be synchronized and updated to match a game clock or other countdown clock 118, and sensors 119. Signal communication transmission 50 from the DCAs to the server 60 may be via network 15 signal communication back to the DCAs 51 from the servers may also be via network. In some instances at least one of signal communication transmission 52 from the DCAs to the server 60 may be via direct communication (radio, white space, wifi, near field, blue-tooth, intranet) and signal communication back to the DCAs 53 from the servers may be via direct communication. Fixed DCAs may by coordinated with other fixed DCAs or other DCAs to measure velocity of direction via triangulation or in other instances by using two reference points.

Sensors may include biometric monitoring of things such as blood pressure, heart rate, temperature, breath, galvanic skin response and other blood components. Sensors may also include rangefinders, weather monitors, wind speed, humidity, precipitation, laser or LED emitters and receptors, spectral signature receivers, UV or infrared illumination. Spectral emitters 120 may also be connected to actors whereby a radio, light or other wave forms a spectral signature which can be received by one or more receivers wherein an individual actor can be identified via the spectral signature from a remote device. Such signature may be non-visible spectrum.

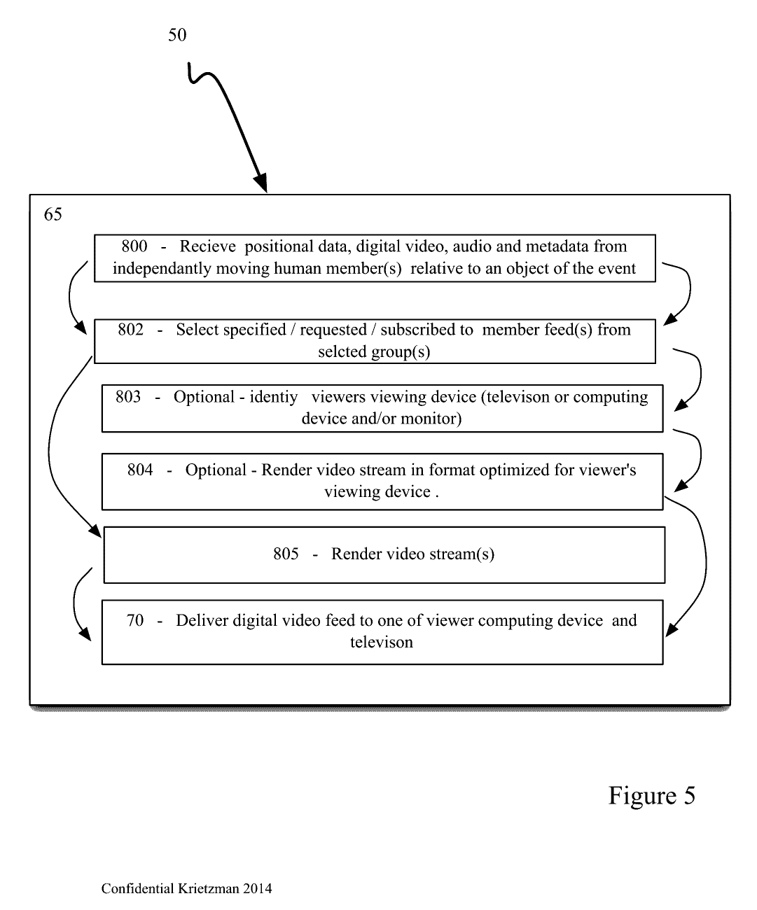

FIG. 5 provides aspects of an exemplar of some processing 65 of digital data received from, or about, at least one of actor (group member) during one or more events. Via the signal communications from one or more DCA provide at least one of actor(s) positional data, digital video, audio and metadata relative to an object at an event site is received 800. In this exemplar the servers are responding to a commanded or instruction to parse through the DCA data feeds and select data feeds the meet criteria 802. Feeds selected may encompass any combination of collected and processed data. Non-limiting examples are actors point of view video and/or audio at different events or actors biometric and point of view, or actors point of view and overview of positional map of actors movement or predicted movement or a compilation of point of views of an object or actor facing actor point of view with each opposing actor being an object. Overlays of additional data or information may also be provided. Optionally, the server may identify or estimate a population members viewing device preference or type 803 and render the data feed to be provided to the population member in a format optimized for population members device 804. If no optional identification or estimate of viewing device then render 805. The sequence then delivers via a network a digital data feed(s) to one of a computing device and television.

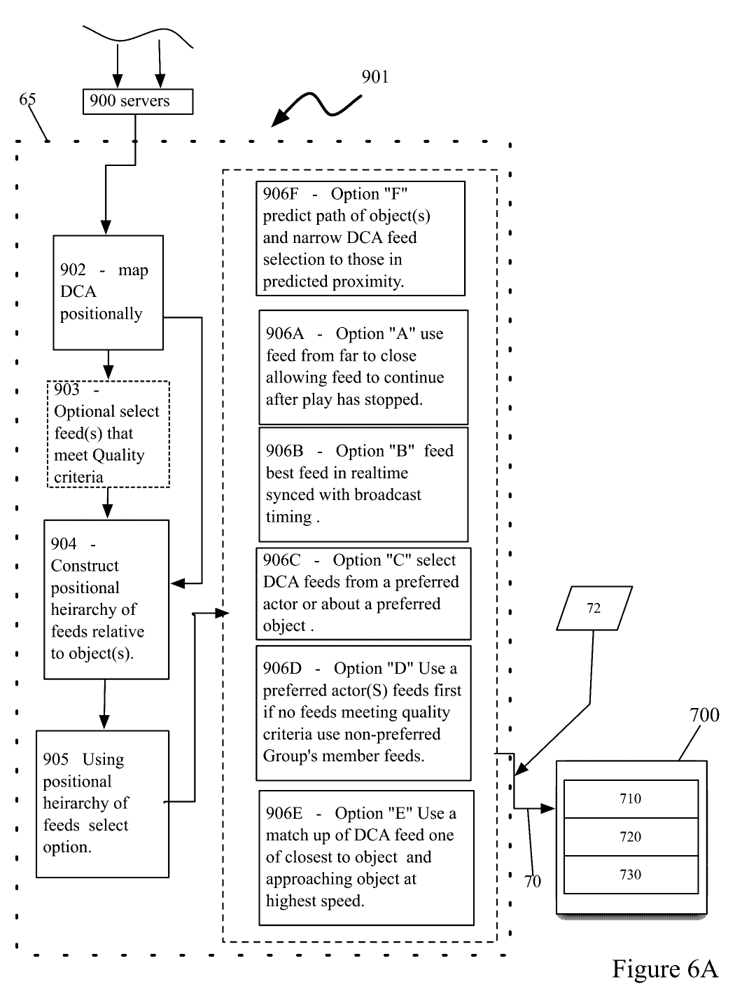

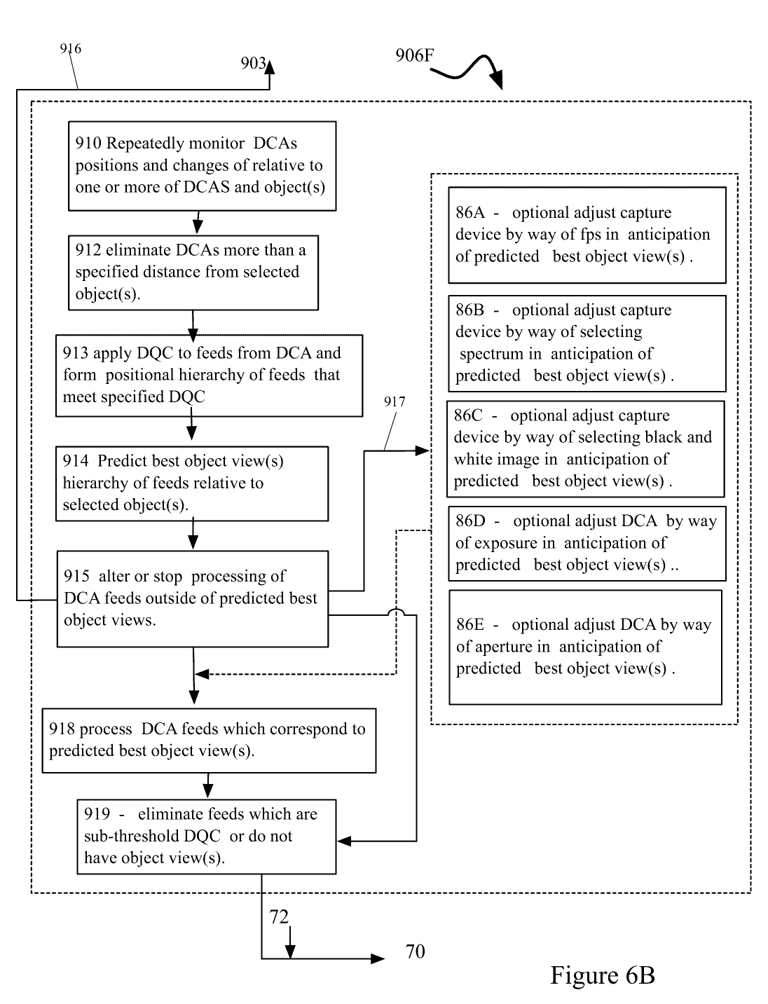

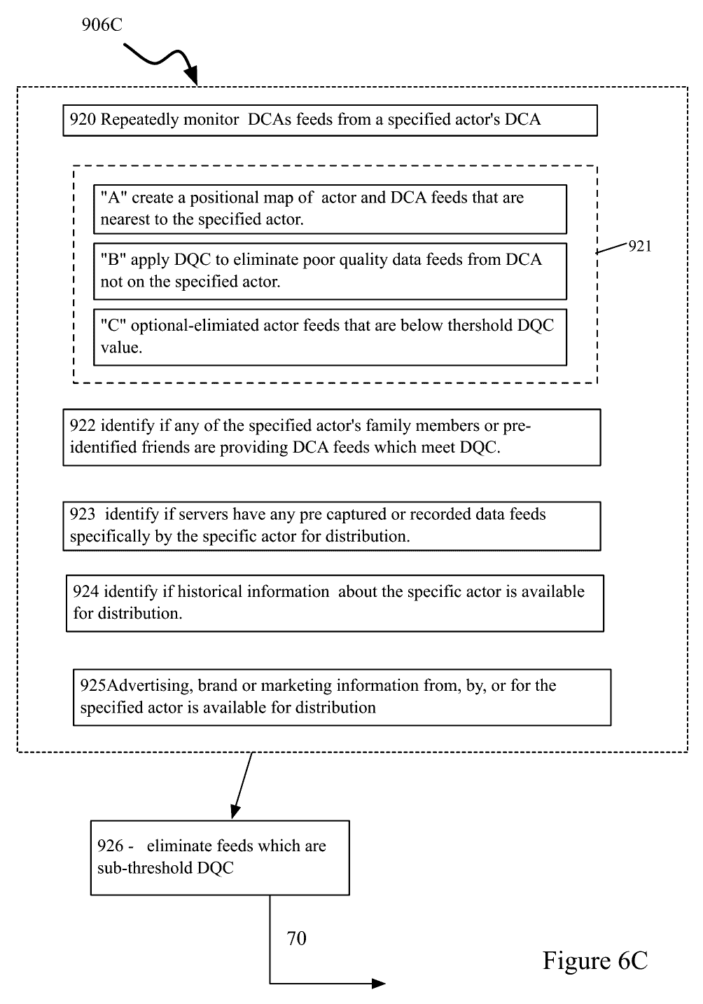

FIG. 6A-6B provide aspects of an exemplar of processing multipoint data collection (MDC) wherein signal containing digital data feeds is received by servers 900 from DCAs and during one or more events.

Processing Module 901 is a processing unit and system. Servers 900 receive data feeds from DCAs which include the DCAs of one or more of actors, drones, fixed, non-actor (coach relative, related but not actor/player) and spectator. The data stream or feeds are then processed. In this exemplar, which is teaching aspects of object tracking, module 901 processes the data, a non-limiting example of a process flow is discussed within. Process steps in this module may be combined with steps in other modules or some steps may be deleted without departing from the scope of this disclosure.

Processing, in some instances, begins with creating a map of locations of DCAs at or near the event or the event site, mapping may include position relative to actors, object(s) of interest 902. The module 901 using at least one of decision, rule and heuristic engines select the data feeds that meet data quality criteria “DQC” for the data type associate with the feed measurements are used to value or devalue samplings of the data which is useful for labeling the data with DQC is a filtering vehicle to reduce feeds which need to be rendered and reviewed. Marking the DQC evaluation of a data feed is also useful for later replay, archive and may be used for processing modules and sub-modules. DQC selections may include, but are not limited to, video quality assurance which includes resolution, focus, color, sharpness, exposure the measurements are used to value or devalue samplings of the data. Audio quality assurance which includes voice recognition, background noise, vile language, and loudness. Sensor information assurance, include determining if the data is reliable. There may be a large quantity of data but its accuracy needs to be confirmed. Confirmation may include comparisons of historical data. If the quantity of sensor data is too small it may not meet be rejected. If the sensory data appears anomalous (outside a predetermine range) it may be rejected. If the sensory data such as speed, direction, or position is contradicted by data from one or more other DCA it may be rejected or devalued. Any given data feed may be subjected to multiple DQC evaluations. In some instances the DQC may be set by a distributor of the information or by a redistributor (broadcaster), in other instances the DQC may be set by a population or sub-population specifications 903. During distribution a companion feed 72 may be added or co-distributed containing advertisements, branding, tagging, marketing, links, or other informational messaging. The processed feed(s) are distributed to a population 700 which may have sub-populations 710-730 and subpopulations may have specific DCA feed request or may set priority or Digital Information Preferences (DIP) to narrow the DCA feeds which servers need to process for distribution.

Processing constructs a positional hierarchy of feeds that meet the DQC relative to a selected object or objects 904. The quality feeds are identified as sources to package the data feeds for a specific distribution 905 which may be based on DIP. A non-limiting list of packaging options include options A-F. The feeds preferably contain a time synchronization or clock which is representative of an event clock. Registered DCAs at the event may be time synced. Spectator and other non-actor DCAs which are allowed to join the data feed to the servers may during registration to provide data fee at a specific event, as part of the registration process, may have an application installed, or have a function turned on in such an application which is already installed, whereby the DCA accepts the MDC clock in place of the normal clock, this may be especially useful in smart phones, mountable streaming camera DCA. In a game situation the DCA clock may be set to a “game clock”. For example if a game is being played and a time out is called which stops the game clock the DCA clock will reflect that pause in time even if it continues to transmit data to the servers.

Six sub-modules also referred to as options A-F are set forth below.

Option A: prepare, which may include one or more of rendering, editing, and combining DCA feeds to reflect distance to or form a selected object. Distribution may be of a feed that is synched with game/event clock and which stops when event clock pauses. Alternatively the feeds may continue during a pause in an event clock, allowing feed to continue after play has stopped.

Option B: 906B selected the best quality DCA feed for time synced distribution to match broadcast timing.

Option C: 906C select DCA feeds from a selected or designated or preferred actors and/or concerning a designated or selected objects. Designations may be via server determination of optimal quality, population choices, or distributor choices, or broadcaster choice, or rebroadcasted choices, or demand valuation or a combination thereof.

Option D: 906D select a DCA from selected or preferred actors first but if no feeds meeting DQC use non-preferred feeds.

Option E: 906E select DCA feed(s) of at least one of closest to object and approaching object at highest speed.

Option F: 906F—Predict path of object(s) and narrow DCA feed selections to those in predicted proximity.

Options need not be mutually exclusive. Option A maybe utilized to display one event feed while option F may be used to distribute another event to the same population

FIG. 6B illustrates a more detailed set of process steps in sub-module 906F which is the Predictive Position Module (PPM), this sub-module predicts object position and actor DCA and/or other DCAs position relative to each other and the object(s) at time intervals, the sub-module provides some filtering and dynamically predicts which DCA feeds should be of the most interest or value as well and may also, in some instances, reduce the universe of DCA feeds that need to be fully considered and processed for the next time interval based on such predictions.

Utilizing data and metadata provided from DCAs to servers, the servers repeatedly monitor and map the positions of one or more DCAs relative to other DCAs and selected object(s) 910. In some instance the direction a DCA is headed towards and the speed of the DCA is also monitored. In some instance the direction multiple DCAs are headed toward and their positions and movement, which may include speed and acceleration of each DCA, towards or retreating from other DCAs is measured. Location mapping may take place before or after DQC is applied to eliminate, or devalue, DCAs feeds which are of a quality below the sub-module threshold. In some instance the sub-module DQC may be the same as the Processing Module 901 DQC. Next is filtering step whereby feeds which are beyond a threshold distance from the object(s) may be eliminated 912. However, in other sub-modules (906C and 906D) feeds which fail to meet a threshold DQC can be given a sub-threshold value. In such sub-modules with sub-threshold value feeds that fit Digital Information Preferences (DIP) of a population 700, such feeds may, in some instance, be distributed,

The PPM sub-module calculates a positional hierarchy of DCA data feeds which meet the DQC threshold. The positional hierarchy is at least one of position on the event site, position to other DCAs and position to an object(s) 913. The sub-module may also filter out feeds that have a data quality criteria “DQC” below a threshold. The threshold may be dynamically adjusted to reflect the quality content of the selected feeds the meet positional requirements at a given point and time. Accordingly, if all available feeds have a quality of data below a threshold DQC value the sub-module can adjust the DQC threshold until such time as an adequate number of higher quality feeds are available.

After developing a positional hierarchy, the sub-module preforms another filtering step via utilizing data and metadata concerning one or more of the DCA position, direction, speed, quality and actor the DCA is connected to, to predict what DCA feeds should provide the next best object view 914. DCA feeds which are outside the universe of DCA feeds predicted (for a time interval) to provide the views sought are one of eliminated from processing and subject to reduced processing 915; instruction to alter the processing of selected DCA feed may be communicated 916 to the servers. Optionally, instructions to adjust DCA parameters, to one of improve feed quality to meet DQC or to alter image data captured, may be wirelessly communicated to the DCAs, which remain in the universe of feeds being considered under the predictive modeling, whereby the DCA are instructed to one or more of:

86A—adjust capture device (DCA) by way of frames per second (FPS) in.

86B—adjust capture device by way of selecting a color spectrum.

86C—adjust capture device by way of selecting black and white imaging.

86D—adjust capture device by way of exposure.

86E—optional adjust video capture device by way of one of aperture.

The predicted best object view feed are then one or more of processed for distribution 918 and filtered 919 to eliminate feeds which are sub-threshold DQC or do not have the object view(s).

Post processed feeds, which include feeds that are from multiple DCA sources and edited or added together in a sequential fashion are then distributed 70 to a population. Optionally, a companion feed may add additional information to the distributed data feed.

FIG. 6C illustrates a more detailed set of process steps in sub-module 906C which is the Actor Specific Module (ASM), this sub-module is a filter to provide feeds of data which are at least one of a specific actors point of view video and audio, data of a specific actor's position, health or biometric data about the actor, recorded or captured feeds starring the specific actor, created by or about the specific actor, feeds form DCA associated with the specific actors friends or family, messages from the specific actor to the population or subpopulations which has requested that actor's feeds and historical statistics, or information about the specific actor.

A plurality of DCA feeds concern or related to the specific actor are received by the servers 60, that information is processed 906C. The servers will repeatedly monitor DCA feeds from a specified actor or actors DCA. 920. The servers will create and update a positional map of the actors location and of DCA feeds 921. That positional map may be hierarchical ordered by one of quality, proximity and source. The feeds from DCAs not mounted to the specified actor are filtered for DQC and poor quality feed may be eliminated. Optionally, the specified actor's captured feeds may also be monitored for quality and those feeds that do not meet DQC thresholds may be eliminated.

During processing, thee may be times when the specific actors feeds are below a DQC threshold, a pause in game, or the specified actor may be not-playing. At such times the servers identify if one or more of:

Any of the specified actor's family members or pre-identified friends are providing DCA feeds which meet DQC 922 and are available for distribution;

Any pre-captured or recorded data feeds by the specific actor for distribution 923;

Historical information about the specific actor is available for distribution 924; and,

Advertising, brand or marketing information from, by, or for the specified actor is available for distribution 925.

Post processed feeds, may go through another DQC filter 926. Distribution to a population follows.

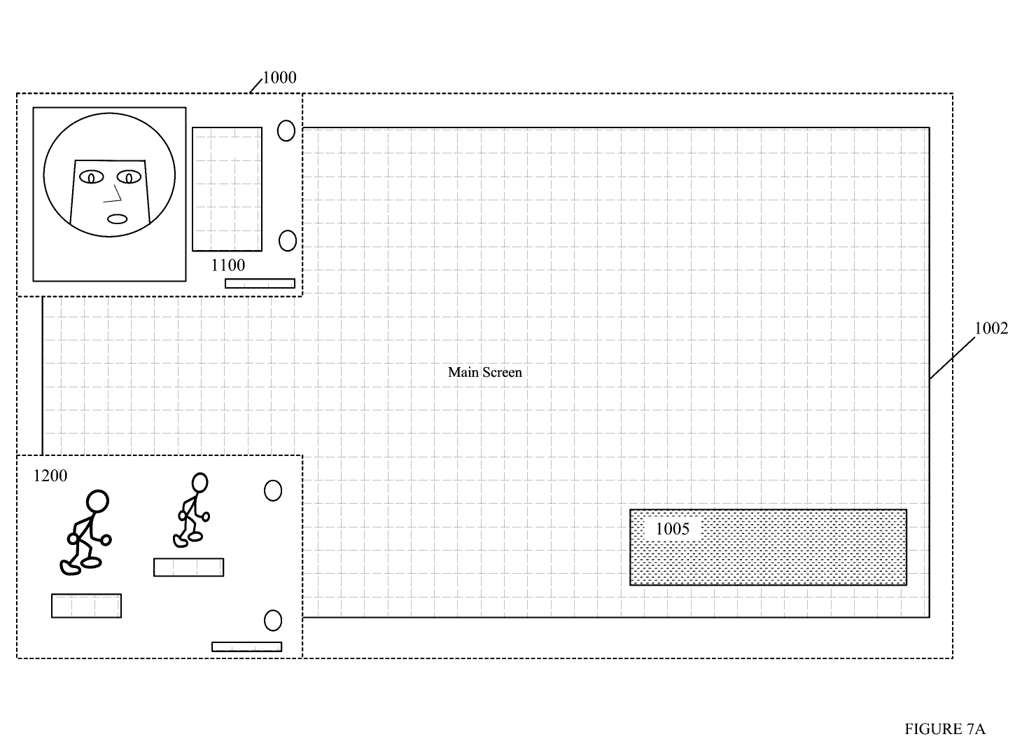

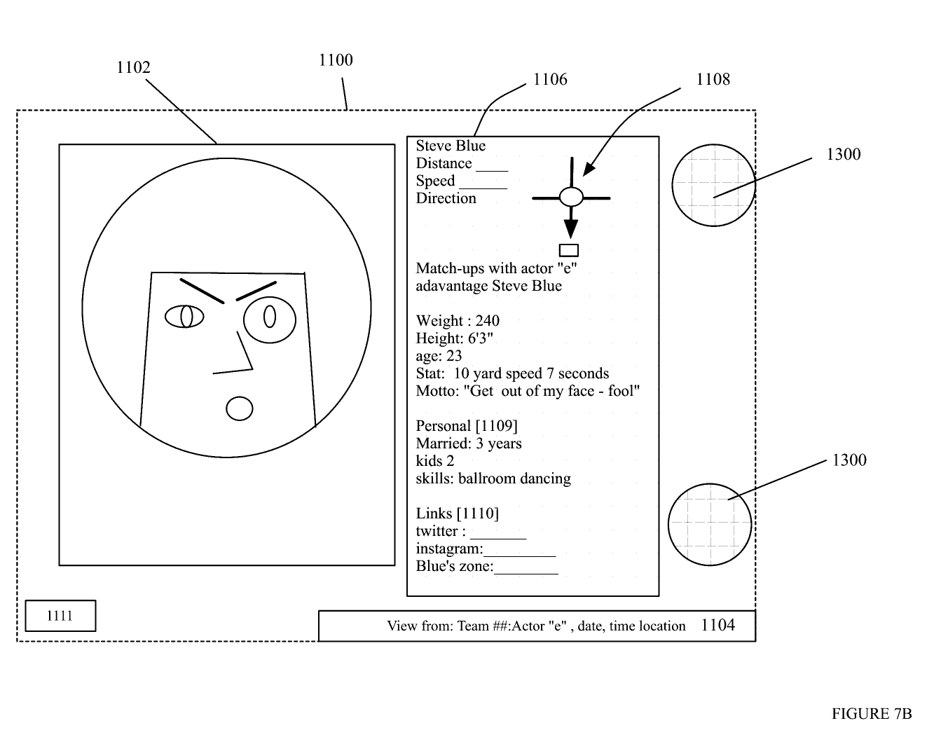

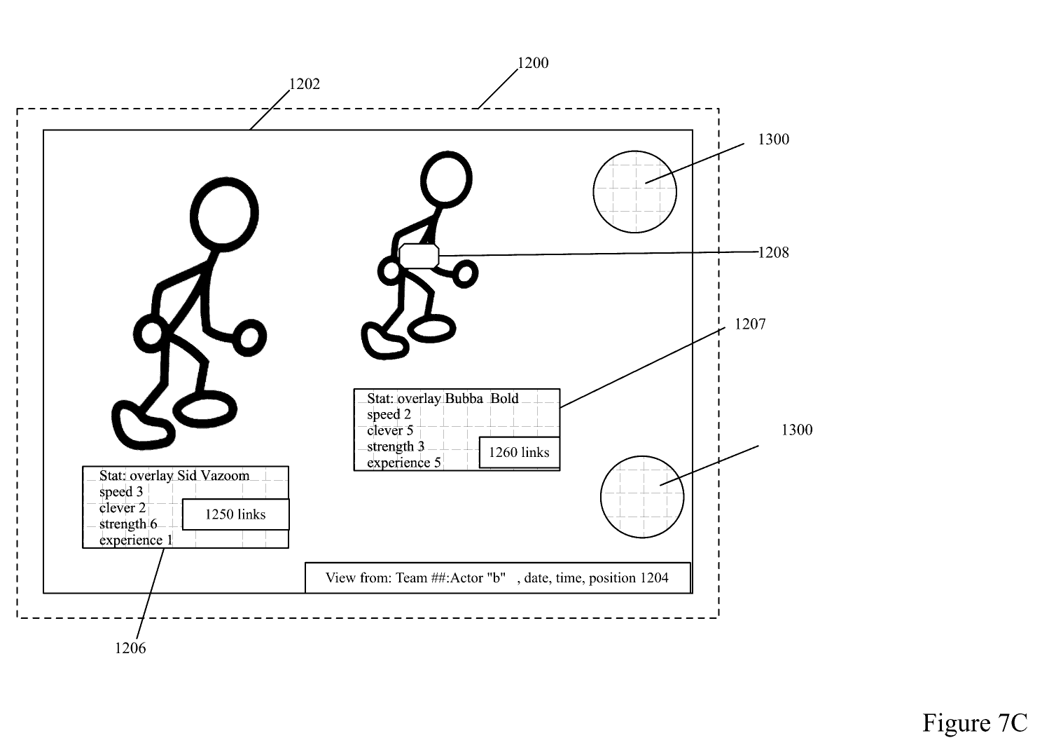

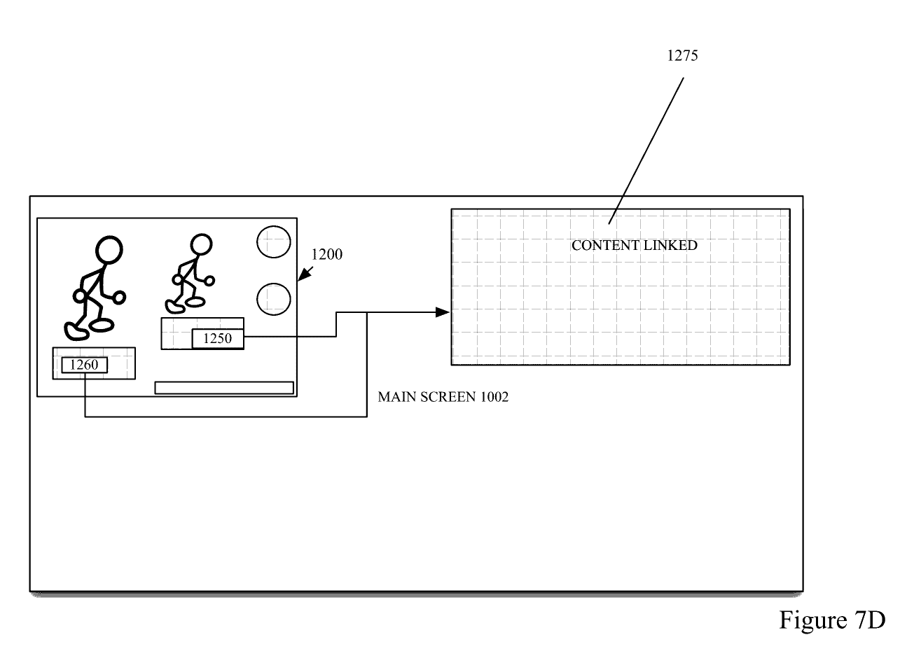

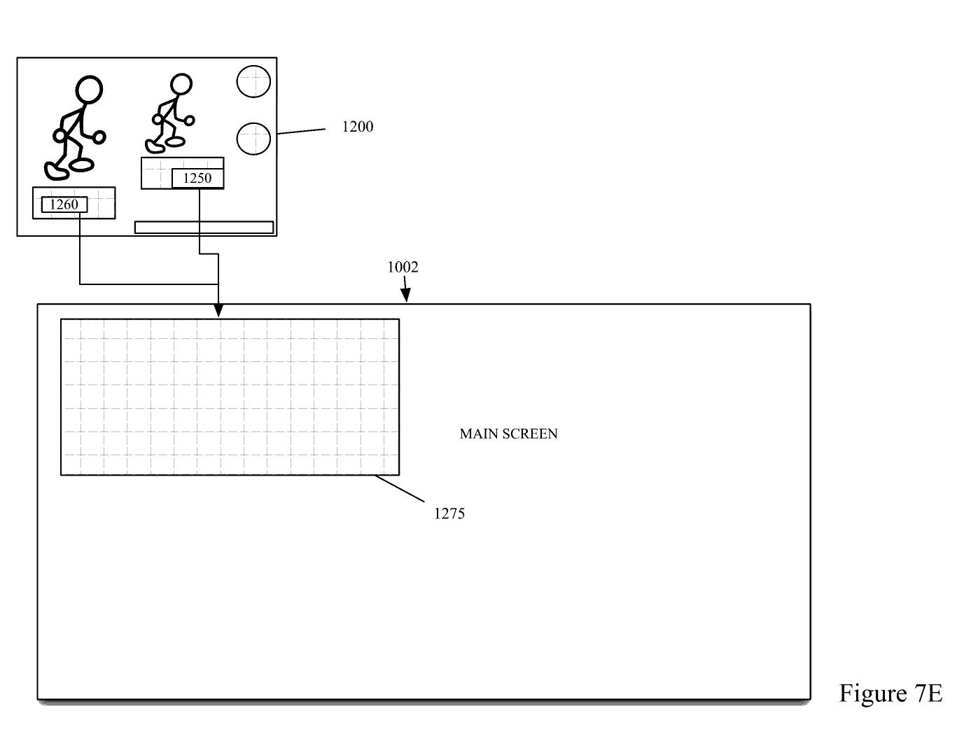

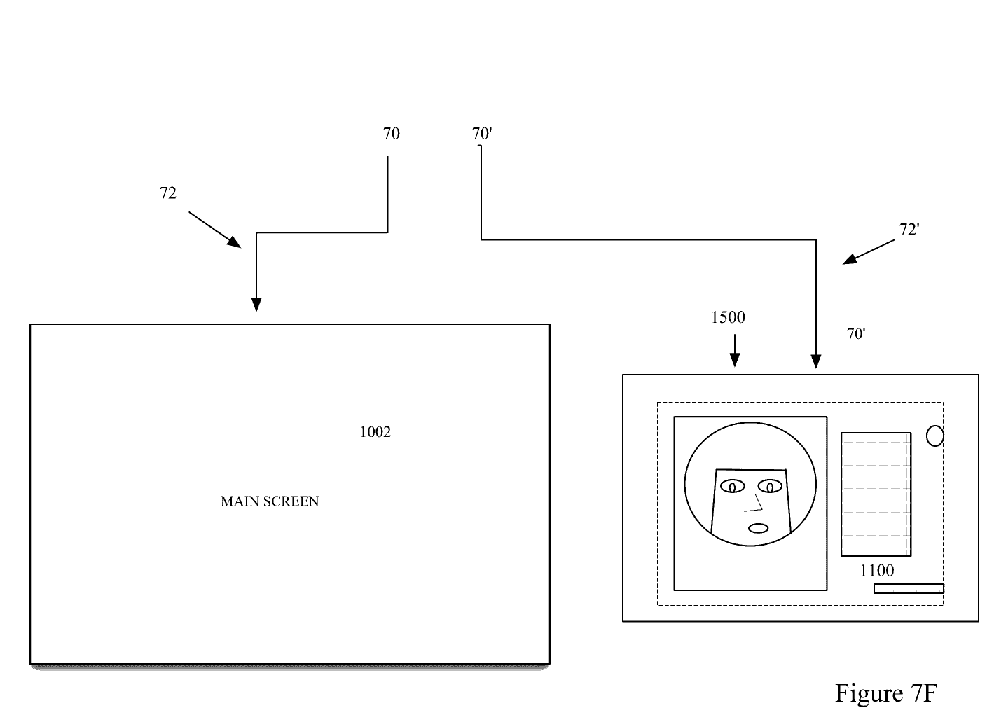

FIGS. 7A-7F illustrate some aspects of lay out and data provided on viewer facing display(s). The display(s) 1000 has limited real estate which is pixelated or otherwise able to display imagery. The display also may have audio outputs and/or speakers. The display may be a smart device having an internet connection which may be remote via a router or integrated into the display. The display 1000 may be in signal communication with the servers 60 whereby it receives the data feeds and information and/or it may receive data streams from a provider such as iptv, Cableco, satellite TV and the like.

The main screen area 1002 is the sum total of available imaging real estate. Illustrated herein are a first actor's point of view (POV) sub-screen 1100 and a second actor's POV sub-screen 1200. Overlay 1005 is a data feed, in illustration of game information, it may also contain hyperlinks to other data feeds, video or audio feed or web pages.

FIG. 7B shows a close up of some information that may be included with the first actor's POV sub-screen. A video feed window or screen 1102 shows the POV of the first actor; an identifier bar or overlay 1104 which may present information such as what actor is connected to the DCA providing the data, the DCA type, gps coordinates, wind speed, temperature, time, direction and the like. Also shown is an enhanced data feed 1106 provides information about what the first actors POV is showing. For example, precaptured or record data concerning each of the actors in a game may be displayed to enhance the population members viewing/interaction experience. In this case it is shown that first actor is looking at: Steve Blue, that Blue is a measured distance of ______ away and has a speed of ______ and the direction icon 1108 shows Blue is heading straight toward first actor. It also shows Blue's weight, height, age, and statistics such as his 10 yard dash speed, and his motto. Personal information 1109 may be provided. Links 1110 such as TWITTER™, FACEBOOK™, INSTAGRAM™ and ones to Blue's own zone which may have coupons, advertising, out takes, in depth data about Blue his family, his hobbies, his manifesto, his pets etc . . . and which is provided for an ultra enhanced mode. To complete the enhanced mode experience, an enhanced data link 1111 to actor “e′s” enhanced data feed is also provided. Advertising, logos, bugs, links, other information data streams 1300s from teams or third parties may be added, including links to advertising and purchasing of goods or services.

FIG. 7C shows a close up of some information that may be included with the second actor's POV sub-screen. A video feed window or screen 1202 shows the POV of the second actor; an identifier bar or overlay 1204 which may present information such as what actor is connected to the DCA providing the data, the DCA type, gps coordinates, wind speed, temperature, time, direction and the like. E data feeds 1206 & 1207 provides information about the two actors the second actors POV is showing. For example, for a first viewed actor 1206 displayed is precaptured or record data concerning each of the actors in a video game type format of statistics: Name: Sid Vazoom, speed level 3, cleverness level 2, strength level 6, experience level 1. The stats may be updated based on performance of the viewed actor during a game event. For example, for a second viewed actor 1207 displayed is pre captured or record data concerning each of the actors in a video game type format of statistics: Name: Bubba Bold, speed level 2, cleverness level 5, strength level 3, experience level 5. The stats may be updated based on performance of the viewed actor during a game event. A football (object) 1208 is also identified in the POV.

Both viewed actors are also shown with links for ultra enhanced mode 1250 & 1260 to viewed actor related information such as TWITTIER™, FACEBOOK™, INSTAGRAM™ and to Bubba and Sid's own zones which may have coupons, advertising, out takes, in depth data about Blue his family, his hobbies, his manifesto, his pets e and which is provided for an ultra enhanced mode. Advertising, logos, bugs, links, other information data streams 1300s from teams or third parties may be add.

FIG. 7D and 7E show a process from selecting an ultra enhanced information flow 1250/1260 and how that information may be displayed 1275 as one of on the main screen 1002 along with a second actor's POV sub-screen 1200, or replacing the second actor's POV sub-screen 1200.

FIG. 7F shows a second screen synchronized feed of collected and processed data. In this instance a population member may receive one set of data feeds on a main screen 1002 and a time synched or near time synched feed on a second display 1500 such as a tablet, computing device or second television. In each instance it is possible to have separate companion data 72 and 72′ transmitted to the different display screens. With smart televisions it is also within the scope of this disclosure that the tablet or computing device screen be a touch screen and can act as a input device to control which stream feeds to which display

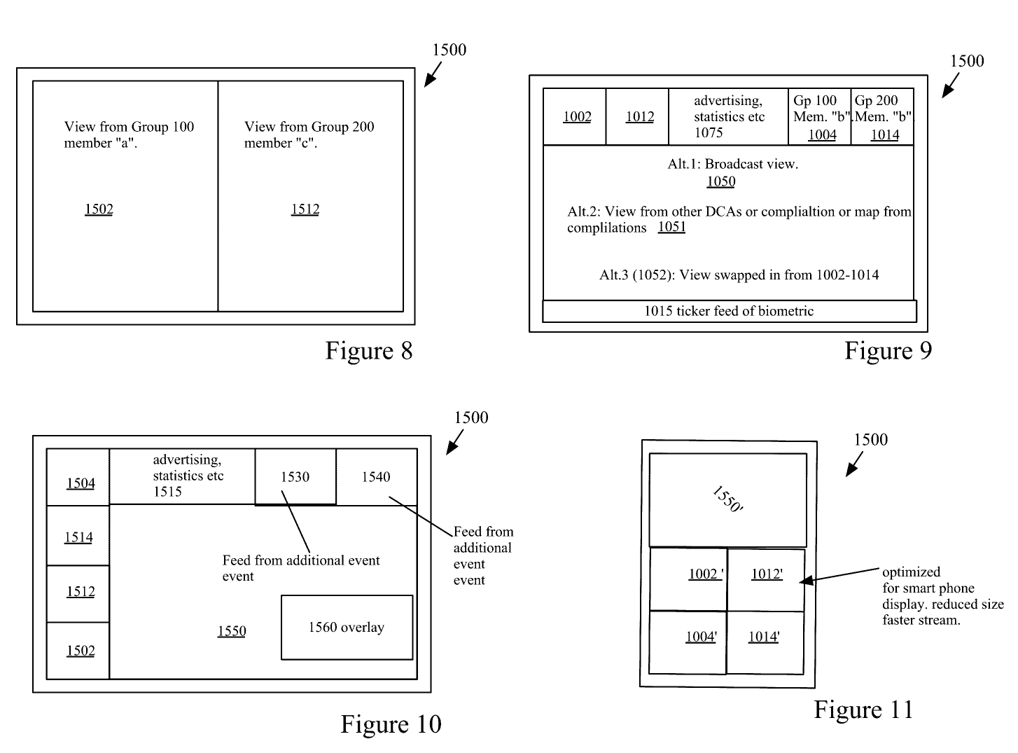

FIGS. 8-11 are not limiting examples of the distribution of content on displays in accordance with aspects of exemplars disclosed herein. On a display 1500 there are a plethora of options on how to divide up the screen space. In FIG. 8 two views (1502 and 1512) from DCA each on a actor from an opposing team are shown side by side and those POV data feeds cover the entire display. In FIG. 9 the display 1500 is divided between a group of actor feeds two from group or team one 1502, 1504, and two from group two or team two 1504, 1514. There is also added a screen 1515 for advertising, statistics and game information, links to advertising and links to purchasing of goods or services. The main screen area 1550 is for the display of data feeds from at least one of an actor, a drone, a fix camera, a non-actor, a spectator, and traditional broadcast.

FIG. 10 adds a new stream of data the display in addition to the feeds described in FIGS. 8 and 9. Feeds from DCA from other events 1530 and 1540. There is also provided an overlay screen 1560 wherein information with adequate transparency is added so that the below video and the overlay may both be viewed. Overlay screen may also present information such as what actor is connected to the DCA providing the data, the DCA type, gps coordinates, wind speed, temperature, time, direction and the like. Finally, FIG. 11 is an example of feeding video optimized (1550′, 1502′, 1504′ 1514′) for a particular display size to that display. Advantages of matching the rendering to optimize the video to a smart phone or tablet as opposed to a wall sized television include faster processing and the for less bandwidth to transmit. In all of the above display exemplars those of ordinary skill in the art will recognize that it is with in the scope of this disclosure to allow viewer (member of population) to swap a smaller display screen such as an actors POV feed for a main screen an vice versa.

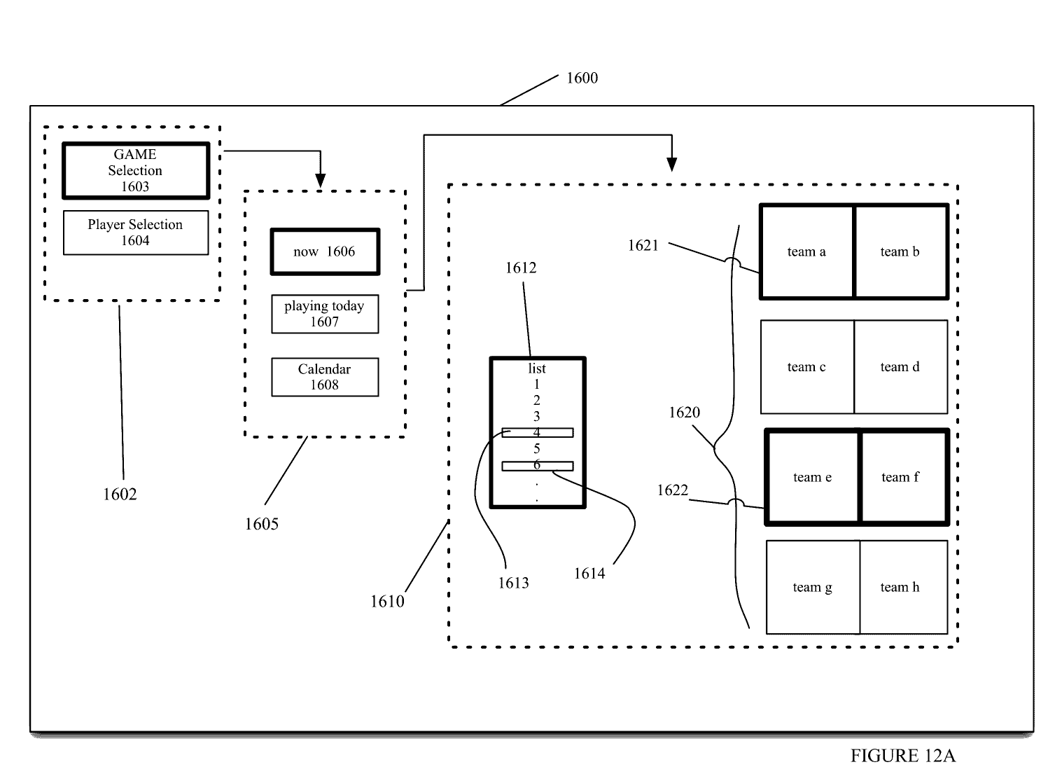

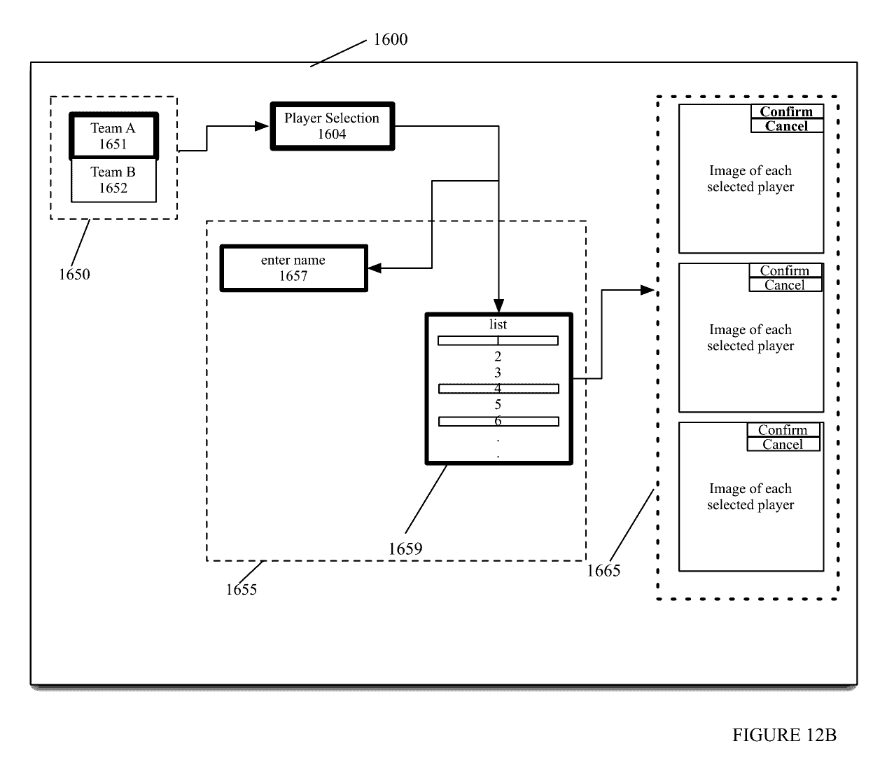

FIGS. 12A-15 illustrate exemplars of a User Interface (UI) or Graphical User Interface (GUI) which may be point and click or touch screen.

FIGS. 12A-12B show a series of modules that represent flow of selections which are part of a UI or GUI on a screen 1600. A viewer may go through the steps to select or filter to the event and/or specific DCA feeds desired. The systems and methods described herein do not all require a viewer to set preferences and in many cases the servers utilizing the rule and decision engines therein can and will select the optimal feeds for distribution based on predefined criteria. However, in those instances wherein more personalization selection and processing of the (MDC) system is sought such personalization is disclosed herein.

In an on-screen or computing device UI or GUI a type selection module 1602 provides a search choice of Game 1603 selection sub-module or a Player (actor) 1604 selection sub-module. FIG. 12A indicates that Game 1603 has been selected. In the universe of sporting events the content of the different categories is fairly well known. Those of ordinary skill in the art will recognize that the method and system disclosed herein is not limited to sporting event. For example, in a non-gaming event such as a news worthy event, the Game Selection choice would be the event (i.e. Crises in Hamsterland, bombing on Moonbase, hurricane in Florida, election in Nigeria) The Player Selection may be used to refer to the different DCA available at that event from newspersons to drones, registered non-newsperson feeds and fixed traditional broadcast feeds.

The calendar module 1605 then provides the viewer a choice of options such as games that are playing now 1606 and events playing today 1607 or a dropdown calendar menu wherein viewer may chose a date. In this example the viewer has selected playing now 1606. The playing now section then initiates the confirmation module 1610 wherein selection buttons are shown as one or more of a list (1612) and an icon (which includes pictures) 1620. In a first instances the viewer has selected from the list 1612 two team match up identified as item “4” (1613) on the list. In another instance the viewer has selected a two team match up identified as item “6” (1614) on the list. In another instance the viewer has selected a match up of team “a” and team “b” (1621). In yet another instance the viewer has selected a match up of team “e” and team “f” (1622).

In an on-screen or computing device UI or GUI a type selection module 1602 provides a search choice of Game 1603 or Player (actor) 1604 selection. FIG. 12A indicates that Game 1603 has been selected. In the universe of sporting events the content of the different categories is fairly well known. Those of ordinary skill in the art will recognize that the method and system disclosed herein is not limited to sporting event. For example, in a non-gaming event such as a news worthy event, the Game Selection choice would be the event (i.e. Crises in Hamsterland, bombing on Moonbase, hurricane in Florida, election in Nigeria) The Player Selection may be used to refer to the different DCA available at that event from newspersons to drones, registered non-newsperson feeds and fixed traditional broadcast feeds.

The calendar module 1605 then provides the viewer a choice of options such as games that are playing now 1606 and events playing today 1607 or s dropdown calendar menu wherein viewer may chose a date. In this example the viewer has selected playing now 1606. The playing now section then initiates the confirmation module 1610 wherein selection buttons are shown as one or more of a list (1612) and an icon (which includes pictures) 1620. In a first instances the viewer has selected from the list 1612 two team match up identified as item “4” (1613) on the list. In another instance the viewer has selected a two team match up identified as item “6” (1614) on the list. In another instance the viewer has selected a match up of team “a” and team “b” (1621). In yet another instance the viewer has selected a match up of team “e” and team “f” (1622).

FIG. 12B is a Digital Information Preferences (DIP) UI or GUI. A team module 1650 is present, the viewer selects Team A (1651) or Team B (1652), that selection initiates a player (actor) selection sub-module 1604 that selection initiates a actor identifier sub-module 1655 wherein via a alpha numeric entry 1657 or pull down list 1659 actors are selected. The actor selection then initiates a verification module 1665 wherein the image (or an icon for) each actor is presented for review and to allow the viewer to confirm or deselect.

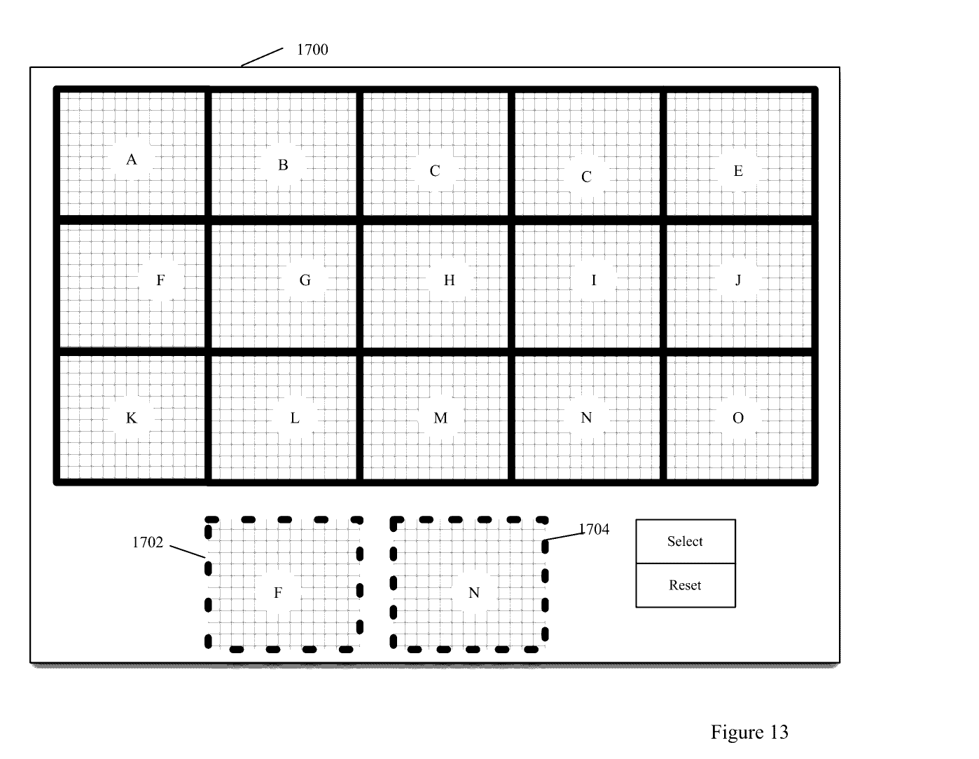

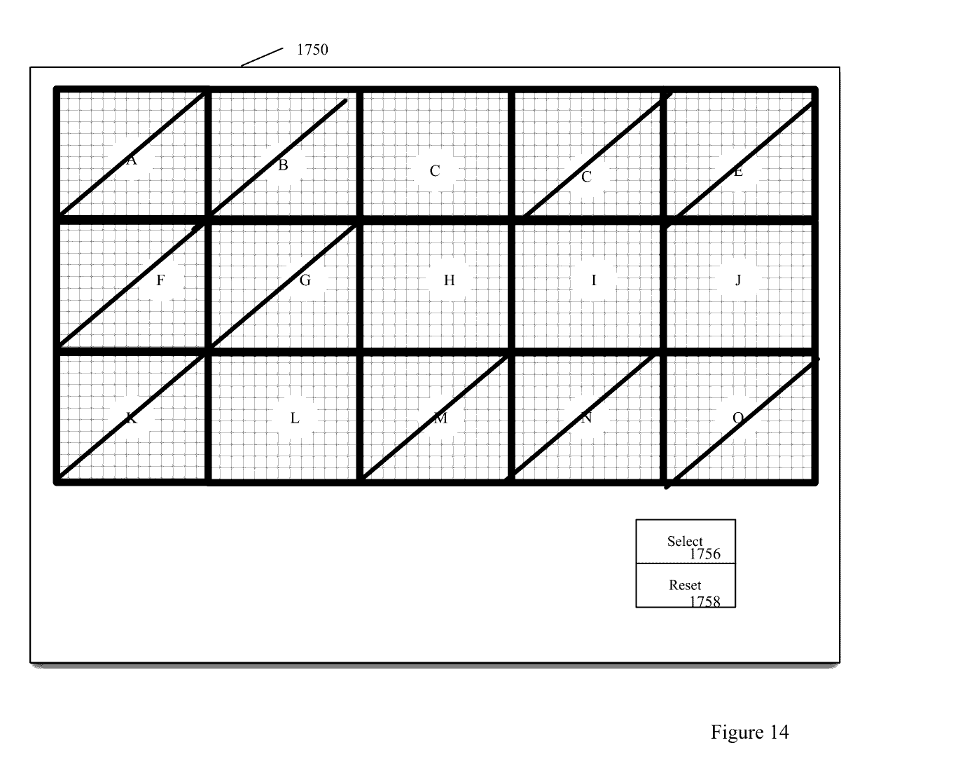

FIGS. 13-15 show viewer facing UI or GUI for team, player (actor) and non player actor DCA feeds. Screen 1700 displays a matrix of icons representing team choices (A-O), the two teams selected are shown as Team “F” 1702 and Team “N” 1704 and the viewer has the option to Select or Reset the section on either team.

FIG. 14 shows a touch screen interface on display 1750 wherein the viewer is selecting actor DCA views. The same type of interface can be used for team selection or non-actor available DCA selection. The choices can be selected or deselected by touching. The choices (A-O) can be confirmed 1752 or Reset 1754.

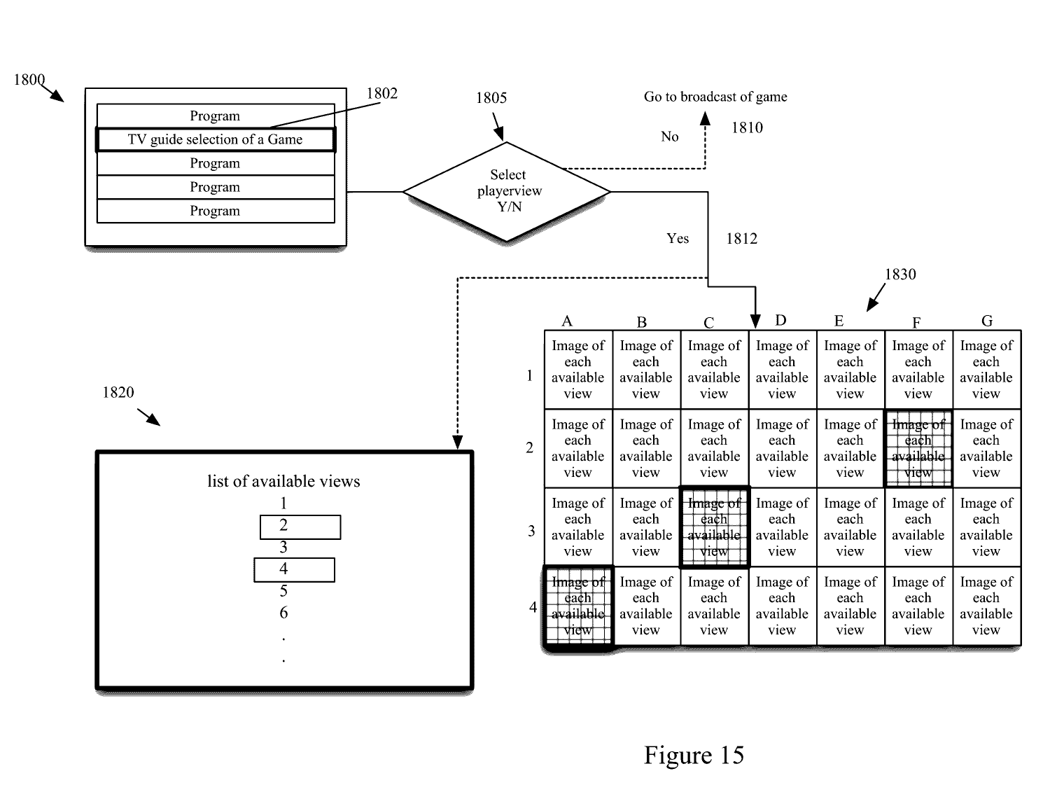

FIG. 15 shows a process flow wherein a television on-demand or programing guide 1800 is able to link to the servers to provide in a selectable matrix (or list)—not shown) of available DCA views. After selecting an event the viewer is given the option to select DCA views 1805. If the viewer declines the normal version 1810 of the event programming is transmitted. IF the viewer selects the chose view option 1812 that will initiate one or more of a list view 120 and a icon view 1830 of available DCA feeds for the event. In this instance the viewer has selected matrix members 4:A, 3:C and 2:F. The DCA views may be actor, non-actor, coach, family members, fixed, drone or any other available feed.

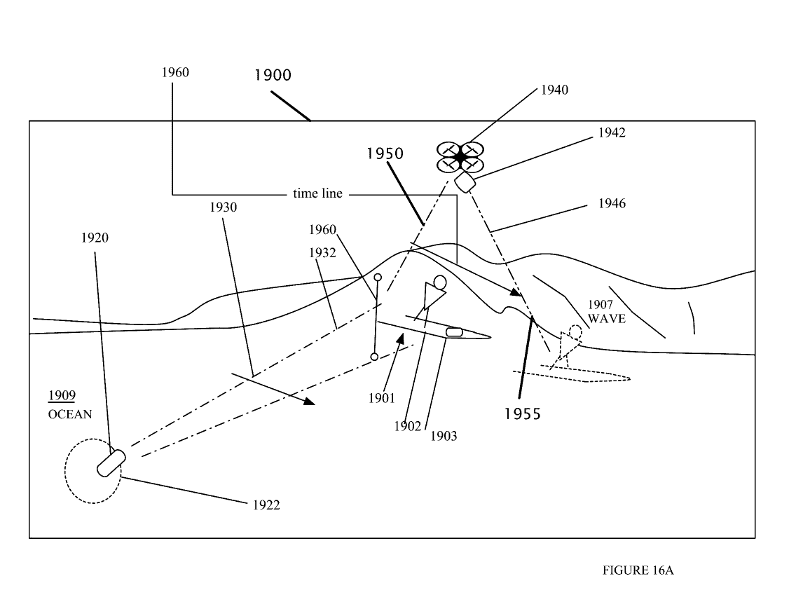

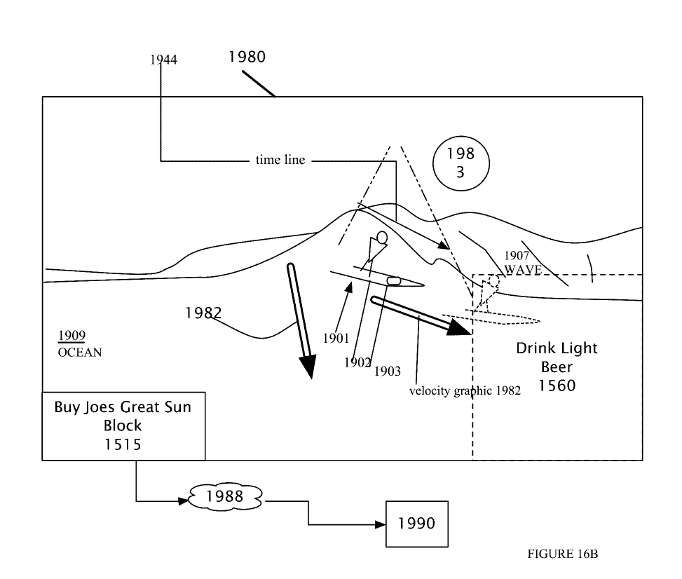

FIG. 16A illustrates a capture of digital of an ocean event 1900 of a surfer 1901 on a board 1902 having a DCA 1903 on a wave 1907 in the ocean 1909. A water based DCA 1920 on a movable base 1922 captures forward movement 1930 of the surfer. A aerial drone 1940 with a DCA 1942 captures overhead movement of surfer from “X, Y” coordinates 1950 to 1955. “Z” axis movement 1960 is also measured and can be measured via DCA on water based drone or aerial drone or on surfboard or surfer mounted not shown) DCAs. over the time 1960.

FIG. 16B illustrates a display 1980 playing the distributed captures of digital images which where acquired by the process described in one or more of FIGS. 1-16A. At this ocean event the surfer's 1901 velocity can be shown as a graphic image such as an arrow 1982 or moving line or a speedometer 1983. The on surfboard DCA 1903 can show images of the actor 1901. Advertisements can be display 1515 on some of the real estate of the display or as an overlay 1560. When the data being displayed is streaming, depending one the screen or device the display is connected to, dynamic advertising may be occurring wherein the population member viewing the data feed may receive advertisements which are targeted to that person or the demographic that person belongs to. The targeting may also be device specific wherein a feed to a tablet or smart phone may be different than the advertising feed to a television. In some instances the advertisement may contain hyperlinks should a viewer which to learn more or order a product displayed.

For a home network an advertisement with hyperlink 1515 can be automated to send 1988 (via a local area network or internet or private network or blue tooth or wifi and the like) the advertisement or a purchase link to another device such as a computer or smartphone 1990 for review at a later time.

It will be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

What is claimed is:

1. A system to agglomerate specific video content which may be distributed time synched with and to augment the broadcast of a gaming event, the system comprising:
within the confines of an event site during a gaming event, collecting first person point of view video via digital capture devices (DCA) mounted on two or more human actors;
collecting positional data on each of said actors relative to an object at the event site;
transmitting the captured data via signal communications to a sever;
processing the captured data at the servers;
editing the data feed; and,
whereby the servers distribute a feed stream of data showing video of a selected object time synced with a game clock suitable for use as a picture in picture during the broadcast or streaming of the gaming event.

2. The system of claim 1 wherein the object is a ball.

4. The system of claim 1 wherein the object is a specific actor.

5. The system of claim 1 wherein the distribution is to a member of a population; and, targeted advertisements are added to the feed based on at least some of the demographic data associated with viewers from the population that follows a player or actor associated with the data feed.

6. A system to agglomerate specific data content which may be distributed time synched with and to augment the broadcast of a gaming event, the system comprising:
within the confines of an event site during a gaming event, collecting first person point of view video via digital capture devices (DCA) mounted on actors;
collecting positional data on each of said actors relative to at least one other specified actor;
transmitting the captured data via signal communications to a sever;
processing the captured data at the servers to create a timeline, synced with the game clock, of actor views of an object; and, distributing a feed stream of actor view data showing video of the selected object time synced with a game clock.

7. The system of claim 6 further comprising during processing providing enhanced data corresponding to a specific actor

8. The system of claim 7 wherein the enhanced data includes at least one of jpeg, mpeg, music, audio, advertisement, video, webpage, messages, and brand endorsement.

9. The system of claim 7 wherein the enhanced data includes at least one an overlay or insert of information such as face, age, weight, statistics, database link, or other link for social media or hyperlink that links to provide the viewer content which could be audio, olfactory, or direct a viewer to (or open) another screen that is the content

10. The system of claim 7 wherein the object is a specific actor.

11. The system of claim 10 further comprising during processing adding enhanced data to an actors DCA video feed corresponding to information about the object.

12. The system of claim 7 further comprising distributing at least some portion of the enhanced data to a second display.

13. A method to agglomerate specific event content which may be distributed after an event with a time sync to augment the distribution of the agglomerated content, the method comprising:
in a specified area collecting video, sensor and audio data via DCA associated with two or more of actors, non-actors, drones and fixed;
transmitting the captured data via signal communications to a sever;
processing the captured data at the servers to create a timeline, synced with a clock, of DCA data feed showing views of one or more selected objects;
distributing a feed stream the processed DCA data feed to one or more members of a population;
distributed with the feed stream one or more targeted advertisements, targeting based on at least some of the demographic data associated with viewers from the population that follows a player or actor associated with the data feed.

14. The method of claim 13 further comprising during processing adding enhanced data to an actors DCA video feed corresponding to information about an actor.

15. The method of claim 14 further comprising distributing at least some portion of the enhanced data to a second display.

16. The method of claim 15 further comprising distributing at least some one of an advertisement and a link to an advertisement to the second display.
